(19) United States
(12) Patent Application Publication
(10) Pub. No.: US 2022/0083866 A1
(43) Pub. Date: Mar. 17, 2022

(54) APPARATUS AND A METHOD FOR NEURAL NETWORK COMPRESSION

(71) Applicant: Nokia Technologies Oy, Espoo (FI)

(72) Inventors: Tinghuai WANG, Tampere (FI); Lixin FAN, Tampere (FI)

(21) Appl. No.: 17/423,314

(22) PCT Filed: Jan. 2, 2020
(86) PCT No.: PCT/FI2020/050006

§ 371 Date: Jul. 15, 2021

(30) Foreign Application Priority Data
Jan. 18, 2019 (FI) 20195032

(51) Int. Cl. G06N 3/08; G06K 9/62

(52) U.S. Cl. CPC G06N 3/082; G06K 9/623

(57) ABSTRACT

There is provided an apparatus comprising means for performing: training a neural network by applying an optimization loss function, wherein the optimization loss function considers empirical errors and model redundancy (210); pruning a trained neural network by removing one or more filters that have insignificant contributions from a set of filters (220); and providing the pruned neural network for transmission (230).

### TECHNICAL FIELD

Various example embodiments relate to compression of neural network(s).

### BACKGROUND

Neural networks have recently prompted an explosion of intelligent applications for IoT devices, such as mobile phones, smart watches and smart home appliances. Because of high computational complexity and battery consumption related to data processing, it is usual to transfer the data to a centralized computation server for processing. However, concerns over data privacy and latency of large volume data transmission have been promoting distributed computation scenarios.

There is, therefore, a need for common communication and representation formats for neural networks to enable efficient transmission of neural network(s) among devices.

### SUMMARY

Now there has been invented an improved method and technical equipment implementing the method, by which the above problems are alleviated. Various aspects comprise an apparatus, a method, and a computer program product comprising a computer program stored therein, which are characterized by what is stated in the independent claims. Various example embodiments are disclosed in the dependent claims.

According to a first aspect, there is provided an apparatus comprising means for performing: training a neural network by applying an optimization loss function, wherein the optimization loss function considers empirical errors and model redundancy; pruning a trained neural network by removing one or more filters that have insignificant contributions from a set of filters; and providing the pruned neural network for transmission.

According to an embodiment, the means are further configured to perform: measuring filter diversities based on normalized cross correlations between weights of filters of the set of filters.

According to an embodiment, the means are further configured to perform: forming a diversity matrix based on pair-wise normalized cross correlations quantified for a set of filter weights at layers of the neural network.

According to an embodiment, the means are further configured to perform: estimating accuracy of the pruned neural network; and retraining the pruned neural network if the accuracy of the pruned neural network is below a pre-defined threshold.

According to an embodiment, the optimization loss function further considers estimated pruning loss and wherein training the neural network comprises minimizing the optimization loss function and the pruning loss.

According to an embodiment, the means are further configured to perform: estimating the pruning loss, the estimating comprising computing a first sum of scaling factors of filters to be removed from the set of filters after training; computing a second sum of scaling factors of the set of filters; and forming a ratio of the first sum and the second sum.

According to an embodiment, the means are further configured to perform, for mini-batches of a training stage: ranking filters of the set of filters according to scaling factors; selecting the filters that are below a threshold percentile of the ranked filters; pruning the selected filters temporarily during optimization of one of the mini-batches; and iteratively repeating the ranking, selecting and pruning for the mini-batches.

According to an embodiment, the threshold percentile is user specified and fixed during training.

According to an embodiment, the threshold percentile is dynamically changed from 0 to a user specified target percentile.

According to an embodiment, the filters are ranked according to a running average of scaling factors.

According to an embodiment, a sum of model redundancy and pruning loss is gradually switched off from the optimization loss function by multiplying with a factor changing from 1 to 0 during the training.

According to an embodiment, the pruning comprises ranking the filters of the set of filters based on column-wise summation of a diversity matrix; and pruning the filters that are below a threshold percentile of the ranked filters.

According to an embodiment, the pruning comprises ranking the filters of the set of filters based on an importance scaling factor; and pruning the filters that are below a threshold percentile of the ranked filters.

According to an embodiment, the pruning comprises ranking the filters of the set of filters based on column-wise summation of a diversity matrix and an importance scaling factor; and pruning the filters that are below a threshold percentile of the ranked filters.

According to an embodiment, the pruning comprises layer-wise pruning and network-wise pruning.

According to an embodiment, the means comprises at least one processor; at least one memory including computer program code; the at least one memory and the computer program code configured to, with the at least one processor, cause the performance of the apparatus.

According to a second aspect, there is provided a method for neural network compression, comprising training a neural network by applying an optimization loss function, wherein the optimization loss function considers empirical errors and model redundancy; pruning a trained neural network by removing one or more filters that have insignificant contributions from a set of filters; and providing the pruned neural network for transmission.

According to a third aspect, there is provided a computer program comprising computer program code configured to, when executed on at least one processor, cause an apparatus to: train a neural network by applying an optimization loss function, wherein the optimization loss function considers empirical errors and model redundancy; prune a trained neural network by removing one or more filters that have insignificant contributions from a set of filters; and provide the pruned neural network for transmission.

According to a fourth aspect, there is provided an apparatus, comprising at least one processor; at least one memory including computer program code; the at least one memory and the computer program code configured to, with the at least one processor, cause the apparatus at least to train a neural network by applying an optimization loss function, wherein the optimization loss function considers empirical errors and model redundancy; prune a trained neural network by removing one or more filters that have insignificant contributions from a set of filters; and provide the pruned neural network for transmission.

### DESCRIPTION OF THE DRAWINGS

In the following, various example embodiments will be described in more detail with reference to the appended drawings, in which

FIG. 1a shows, by way of example, a system and apparatuses in which compression of neural networks may be applied;

FIG. 1b shows, by way of example, a block diagram of an apparatus;

FIG. 2 shows, by way of example, a flowchart of a method for neural network compression;

FIG. 3 shows, by way of example, an illustration of neural network compression; and

FIG. 4 shows, by way of example, a distribution of scaling factors for filters.

### DESCRIPTION OF EXAMPLE EMBODIMENTS

A neural network (NN) is a computation graph comprising several layers of computation. Each layer comprises one or more units, where each unit performs an elementary computation. A unit is connected to one or more other units, and the connection may have associated a weight. The weight may be used for scaling a signal passing through the associated connection. Weights may be learnable parameters, i.e., values which may be learned from training data. There may be other learnable parameters, such as those of batch-normalization (BN) layers.

The neural networks may be trained to learn properties from input data, either in supervised way or in unsupervised way. Such learning is a result of a training algorithm, or of a meta-level neural network providing a training signal. The training algorithm changes some properties of the neural network so that its output is as close as possible to a desired output. For example, in the case of classification of objects in images, the output of the neural network can be used to derive a class or category index which indicates the class or category that the object in the input image belongs to. Examples of classes or categories may be e.g. “person”, “cat”, “dog”, “building”, “sky”.

Training usually happens by changing the learnable parameters so as to minimize or decrease the output's error, also referred to as the loss. The loss may be e.g. a mean squared error or cross-entropy. In recent deep learning techniques, training is an iterative process, where at each iteration the algorithm modifies the weights of the neural net to make a gradual improvement of the network's output, i.e., to gradually decrease the loss.

Training a neural network is an optimization process, but the final goal is different from the typical goal of optimization. In optimization, the only goal is to minimize a functional. In machine learning, the goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization.

The network to be trained may be a classifier neural network, such as a Convolutional Neural Network (CNN) capable of classifying objects or scenes in input images.

Trained models or parts of deep Neural Networks (NN) may be shared in order to enable rapid progress of research and development of AI systems. The NN models are often complex and demand a lot of computational resources which may make sharing of the NN models inefficient.

There is provided a method and an apparatus to enable compressed representation of neural networks and efficient transmission of neural network(s) among devices.

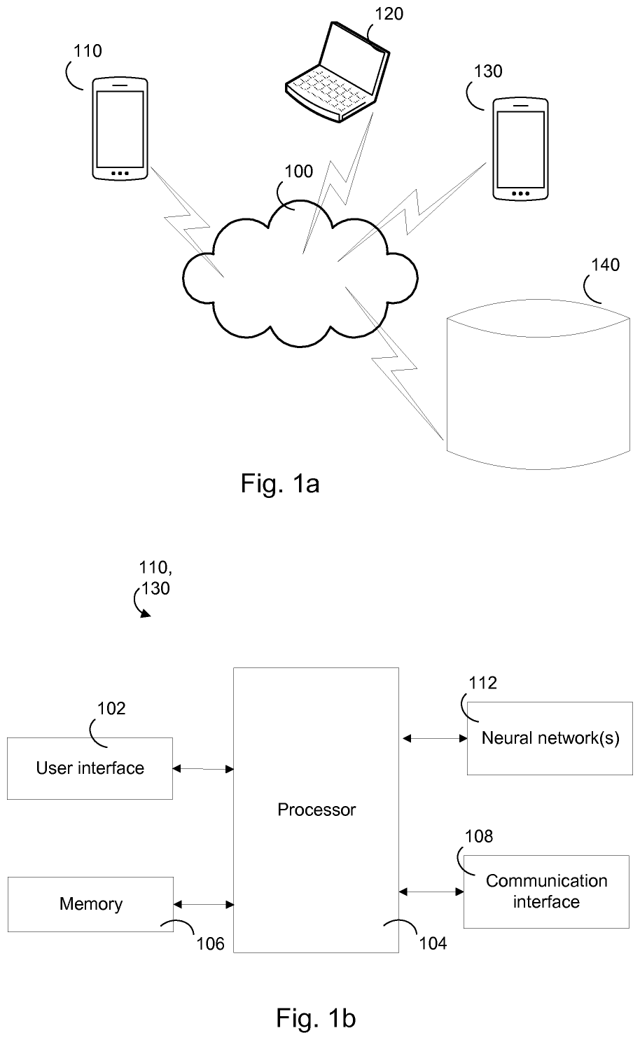

FIG. 1a shows, by way of example, a system and apparatuses in which compression of neural networks may be applied. The different devices 110, 120, 130, 140 may be connected to each other via a communication connection 100, e.g. vie Internet, a mobile communication network, Wireless Local Area Network (WLAN), Bluetooth®, or other contemporary and future networks. Different networks may be connected to each other by means of a communication interface. The apparatus may be e.g. a server 140, a personal computer 120, a laptop 120 or a smartphone 110, 130 comprising and being able to run at least one neural network. The one or more apparatuses may be part of a distributed computation scenario, wherein there is a need to transmit neural network(s) from one apparatus to another. Data for training the neural network may be received by the one or more apparatuses e.g. from a database such as a server 140. Data may be e.g. image data, video data etc. Image data may be captured by the apparatus 110, 130 by itself, e.g. using a camera of the apparatus.

FIG. 1b shows, by way of example, a block diagram of an apparatus 110, 130. The apparatus may comprise a user interface 102. The user interface may receive user input e.g. through a touch screen and/or a keypad. Alternatively, the user interface may receive user input from internet or a personal computer or a smartphone via a communication interface 108. The apparatus may comprise means such as circuitry and electronics for handling, receiving and transmitting data. The apparatus may comprise a memory 106 for storing data and computer program code which can be executed by a processor 104 to carry out various embodiment of the method as disclosed herein. The apparatus comprises and is able to run at least one neural network 112. The elements of the method may be implemented as a software component residing in the apparatus or distributed across several apparatuses. Processor 104 may include processor circuitry. The computer program code may be embodied on a non-transitory computer readable medium.

As used in this application, the term “circuitry” may refer to one or more or all of the following: (a) hardware-only circuit implementations (such as implementations in only analog and/or digital circuitry) and (b) combinations of hardware circuits and software, such as (as applicable):

(i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

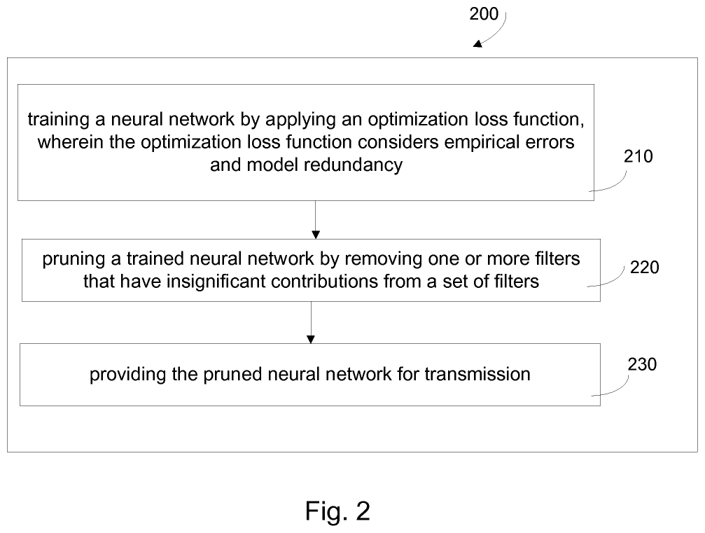

FIG. 2 shows, by way of an example, a flowchart of a method 200 for neural network compression. The method 200 comprises training 210 a neural network by applying an optimization loss function, wherein the optimization loss function considers empirical errors and model redundancy. The method 200 comprises pruning 220 a trained neural network by removing one or more filters that have insignificant contributions from a set of filters. The method 200 comprises providing 230 the pruned neural network for transmission.

The method disclosed herein provides for enhanced diversity of neural networks. The method enables pruning redundant neural network parts in an optimized manner. In other words, the method reduces filter redundancies at the layers of the NN and compresses the number of NN parameters. The method imposes constraints during the learning stage, such that learned parameters of NN are orthogonal and independent with respect to each other as much as possible. The outcome of the neural network compression is a representation of the neural network which is compact in terms of model complexities and sizes, and yet comparable to the original, uncompressed, NN in terms of performances.

The method may be implemented in an off-line mode or in an on-line mode.

In the off-line mode, a neural network is trained by applying an optimization loss function considering empirical errors and model redundancy. Defined loss function, i.e. a first loss function, may be written as

Loss=Error+weight redundancy.

Given network architectures may be trained with the original task performance optimized, without imposing any constraints on learned network parameters, i.e. weights and bias terms. Mathematically, this general optimization task may be described by:

W*=arg min E₀(W,D),

wherein D denotes the training dataset, and E₀ the task objective function e.g. class-wise cross-entropy for image classification task. W denotes the weights of the neural network.

In the method disclosed herein, the optimization loss function, i.e. the objective function of filter diversity enhanced NN learning may be formulated by:

W*=arg min E₀(W,D)+λK_{θ}(W),

wherein λ is the parameter to control relative significance of the original task and the filter diversity enhancement term K_{θ}, and θ is the parameter to measure filter diversities used in function K. W* above represents the first loss function.

Filter diversities may be measured based on Normalized Cross Correlations between weights of filters of a set of filters. Filter diversities may be measured by quantifying pair-wise Normalized Cross Correlation (NCC) between weights of two filters represented as weight vectors e.g. Wᵢ, Wⱼ:

$${C}_{i j} = 〈 \frac{{W}_{i}}{\vert W\_i \vert} , \frac{{W}_{j}}{\vert {W}_{j} \vert} 〉 ,$$

in which [symbol] , [symbol] denotes dot product of two vectors. Note that Cᵢⱼ is between [−1, 1] due to the normalization of Wᵢ, Wⱼ.

A diversity matrix may be formed based on pair-wise NCCs quantified for a set of filter weights at layers of the neural network. For a set of filter weights at each layer i.e. Wᵢ, i={1, . . . , N}, all pair-wise NCCs constitute a matrix:

$${M}_{C} = [ \begin{matrix}{C}_{11} & … & {C}_{1 N} \\ ⋮ & ⋱ & ⋮ \\ {C}_{N 1} & … & {C}_{NN}\end{matrix} ] , \qquad ( 1 )$$

with its diagonal elements C₁₁ . . . C_{NN}=1.

The filter diversity K^{l}_{θ} at layer l may be defined based on NCC matrix:

K^{l}_{θ}=Σ_{i,j=1}^{N,N}|Cᵢⱼ| (2).

A total filter diversity term K_{θ}=ΣK^{l}_{θ}, is the sum of filter diversities at all layers l=1 . . . L. The diversity is getting smaller as K_{θ} gets smaller.

The trained neural network may be pruned by removing one or more filters that have insignificant contribution from a set of filters. There are alternative pruning schemes. For example, in diversity based pruning, the filters of the set of filters may be ranked based on column-wise summation of the diversity matrix (1). These summations may be used to quantify the diversity of a given filter with regard to other filters in the set of filters. The filters may be arranged in descending order of the column-wise summations of the diversities. The filters that are below a threshold percentile p % of the ranked filters may be pruned. A value p of the threshold percentile may be e.g. user-defined. The value p may be any value from zero to 1, and is subject to requirements on performance, e.g. accuracy, of the model, and on model size. For example, p may be 0.75 for VGG19 network on CIFAR-10 dataset without significantly losing accuracy. As another example, p may be 0.6 for VGG19 network on CIFAR-100 dataset without significantly losing accuracy. The p of a value 0.75 means that 75% of the filters are pruned. Correspondingly, the p of a value of 0.6 means that 60% of the filters are pruned.

As another example, scaling factor based pruning may be applied. The filters of the set of filters may be ranked based on importance scaling factors. For example, a Batch-Normalization (BN) based scaling factor may be used to quantify the importance of different filters. The scaling factor may be obtained from e.g. batch-normalization or additional scaling layer. The filters may be arranged in descending order of the scaling factor, e.g. the BN-based scaling factor. The filters that are below a threshold percentile p % of the ranked filters may be pruned. A value p of the threshold percentile may be e.g. user-defined. The value p may be any value from zero to 1, and is subject to requirements on performance, e.g. accuracy, of the model, and on model size.

As yet another example, a combination approach may be applied to prune filters. In the combination approach, the scaling factor based pruning and the diversity based pruning are combined. For example, the ranking results of the both pruning schemes may be combined, e.g. by applying an average or a weighted average. Then, the filters may be arranged according to the combined results. The filters that are below a threshold percentile p % of the ranked filters may be pruned. A value p of the threshold percentile may be e.g. user-defined. The value p may be any value from zero to 1, and is subject to requirements on performance, e.g. accuracy, of the model, and on model size.

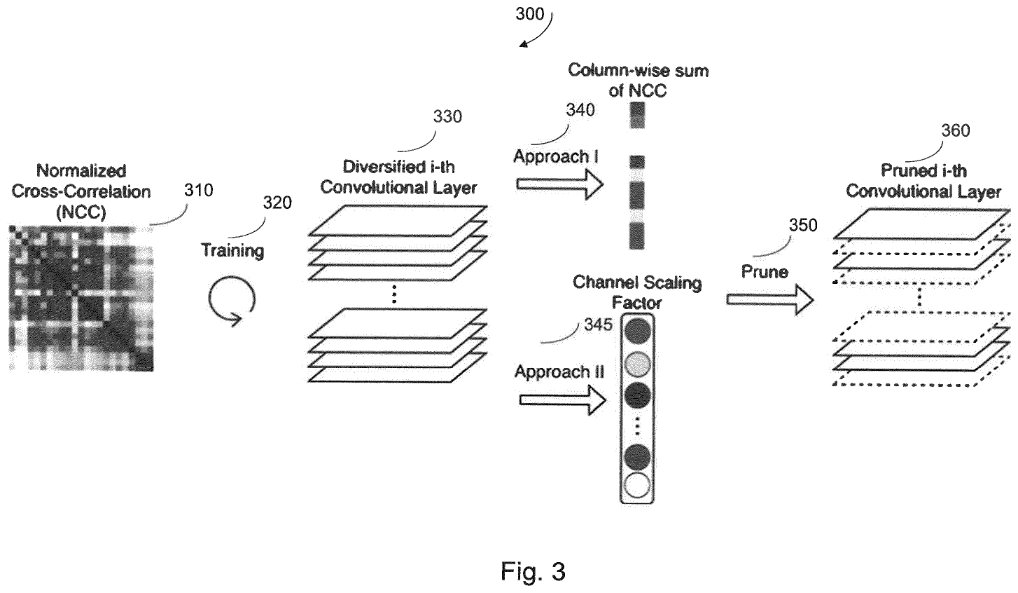

FIG. 3 shows, by way of example, an illustration 300 of neural network compression. The Normalized Cross-Correlation (NCC) 310 matrix, the diversity matrix, comprises the pair-wise NCCs for a set of filter weights at each layer with its diagonal elements being 1. The training 320 of a neural network may be performed by applying an optimization loss function, wherein the optimization loss function considers empirical errors and model redundancy. The diversified i^{th} convolutional layer 320 represents a layer of a trained network.

Alternative pruning schemes 340, 345 may be applied for the trained network. The combination approach described earlier is not shown in the example of FIG. 3 but it may be applied as an alternative to the approaches I and II. The Approach I 340 represents diversity based pruning, wherein the filters of the set of filters may be ranked based on column-wise summation of the diversity matrix (1). These summations may be used to quantify the diversity of a given filter with regard to other filters in the set of filters. The filters may be arranged in descending order of the column-wise summations of the diversities. The filters that are below a threshold percentile p % of the ranked filters may be pruned 350. A value p of the threshold percentile may be e.g. user-defined. The value p may be any value from zero to 1, and is subject to requirements on performance, e.g. accuracy, of the model, and on model size.

The Approach II 345 represents scaling factor based pruning. The filters of the set of filters may be ranked based on importance scaling factors. For example, a Batch-Normalization (BN) based scaling factor may be used to quantify the importance of different filters. The filters may be arranged in descending order of the scaling factor, e.g. the BN-based scaling factor. The filters that are below a threshold percentile p % of the ranked filters may be pruned 350. A value p of the threshold percentile may be e.g. user-defined. The value p may be any value from zero to 1, and is subject to requirements on performance, e.g. accuracy, of the model, and on model size.

As a result of pruning 350, there is provided a pruned i^{th} convolutional layer 360. The filters illustrated using a dashed line represent the pruned filters. The pruned network may be provided for transmission from an apparatus wherein the compression of the network is performed to another apparatus. The pruned network may be transmitted from an apparatus to another apparatus.

Table 1 below shows accuracies of off-line mode pruned VGG19 network at various pruning rates.

| Pruning rate | 10% | 20% | 30% | 40% | 50% | 60% | 70% |
|---|---|---|---|---|---|---|---|
| Accuracy | 0.9361 | 0.9359 | 0.9375 | 0.9348 | 0.9353 | 0.9394 | 0.9373 |

As can be seen in the table 1, even when pruning rate of 70% is applied, the accuracy is high, even 0.9373.

Pruning the network in the off-line mode may cause a loss of performance, e.g. when the pruning is excessive. For example, accuracy of image classification may be reduced. Therefore, the pruned network may be retrained, i.e. fine-tuned with regard to the original dataset to retain its original performance. Table 2 below shows improved accuracies after applying retraining to a VGG19 network pruned with 70% and 75% percentiles. The network pruned at 70% achieves sufficient accuracy which thus does not require retraining, while the network pruned at 75% shows degraded performance and thus requires retraining to restore its performance. Sufficient accuracy is use case dependent, and may be pre-defined e.g. by a user. For example, accuracy loss of approximately 2% due to pruning may be considered acceptable. It is to be understood, that in some cases, acceptable accuracy loss may be different, e.g. 2.5% or 3%.

| | Accuracy Before | Accuracy After |
|---|---|---|
| | Retraining | Retraining |
| Pruning at 70% | 0.9211 | NA |
| Pruning at 75% | 0.8232 | 0.9379 |

The method may comprise estimating accuracy of the network after pruning. For example, the accuracy of the image classification may be estimated using a known dataset. If the accuracy is below a threshold accuracy, the method may comprise retraining the pruned network. Then the accuracy may be estimated again, and the retraining may be repeated until the threshold accuracy is achieved.

In the on-line mode, a neural network is trained by applying an optimization loss function considering empirical errors and model redundancy and further, estimated pruning loss, i.e. loss incurred by pruning. The defined loss function, i.e. a second loss function, may be written as

Loss=Error+weight redundancy+pruning loss.

The loss incurred by pruning is iteratively estimated and minimized during the optimization. Thus, the training of the neural network may comprise minimizing the optimization loss function and the pruning loss. Minimization of the pruning loss ensures that potential damages caused by pruning do not exceed a given threshold. Thus, there is no need of a post-pruning retraining stage of the off-line mode.

When the pruning loss is taken into account during the learning stage, potential performance loss caused by pruning of filters may be alleviated.

When the pruning loss is taken into account during the learning stage, unimportant filters may be safely removed from the trained networks without compromising the final performance of the compressed network.

When the pruning loss is taken into account during the learning stage, possible retraining stage of the off-line pruning mode is not needed. Thus, extra computational costs investigated on the possible retraining stage may be avoided.

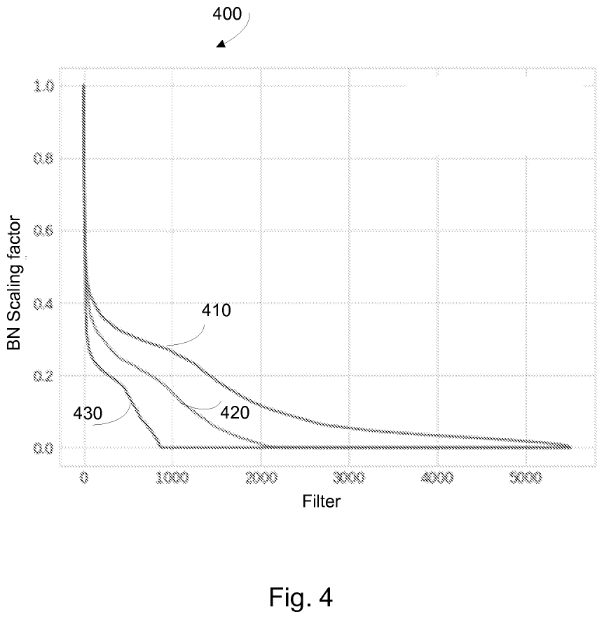

When the pruning loss is taken into account during the learning stage, the strengths of important filters will be boosted and the unimportant filters will be suppressed, as shown in FIG. 4. Neural network model diversities are enhanced during the learning process, and the redundant neural network parts, e.g. filters or convolutional filters, are removed without compromising performances of original tasks.

The method may comprise estimating the pruning loss. In order to estimate potential pruning loss for a given set of filters Γ associated with scaling factors γᵢ, we use the following formula to define the pruning loss:

$${γ}^{P} = \frac{{Σ}_{i ∈ P ( Γ )} {γ}_{i}}{{Σ}_{i ∈ Γ} {γ}_{i}} , \qquad ( 3 )$$

in which P(Γ) is the set of filters to be removed after training. The scaling factors may be e.g. the BN scaling factors. The scaling factor may be obtained from e.g. batch-normalization or additional scaling layer. Numerator in the equation 3 is a first sum of scaling factors of filters to be removed from the set of filters after training. The denominator in the equation 3 is a second sum of scaling factors of the set of filters. A ratio of the first sum and the second sum is the pruning loss.

So, the objective function in the on-line mode may be formulated by

W*=arg min E₀(W,D)+λK_{θ}(W)+γ^{P}.

W* above represents the second loss function.

FIG. 4 illustrates, by way of example, a distribution of scaling factors for all filters. The x-axis refers to the id (0-N) of sorted filters in descending order of their associated scaling factors. The line 410 represents base-line, the line 420 represents scaling factors after applying network slimming compression method, and the line 430 represents the scaling factors after applying compression method disclosed herein. The base-line 410 represents an original model which is not pruned. Clearly one can observe based on the line 430 that, once the pruning loss is incorporated into the optimization objective function, i.e. minimization objective function, scaling factors associated with pruned filters are significantly suppressed while scaling factors are enhanced for remaining filters. The pruning loss as well as the training loss are both minimized during the learning stage. Tendency for scaling factors being dominated by remaining filters is not pronounced for the optimization process without incorporating the pruning loss.

In the on-line mode, dynamic pruning approach may be applied to ensure the scaling factor based pruning loss is a reliable and stable estimation of real pruning loss. For each mini-batch of the training stage, the following steps may be iteratively applied; the filters of the set of filters may be ranked according to associated scaling factors γᵢ. Then, filters that are below a threshold percentile p % of the ranked filters may be selected. Those selected filters, which are candidates to be removed after the training stage, may be switched off by enforcing their outputs to zero i.e. temporarily pruned during the optimization of one mini-batch.

According to an embodiment, the parameter p of the lower p % percentile is user specified and fixed during the learning process/training.

According to an embodiment, the parameter p is dynamically changed, e.g. from 0 to a user specified target percentage p %.

According to an embodiment, the parameter p is automatically determined during the learning stage, by minimizing the designated object function.

According to an embodiment, the ranking of the filters is performed according to the Running Average of Scaling Factors which is defined as follows:

γ̅ᵢ^{t}=(1−k)γ̅ᵢ^{t-1}+kγᵢ^{t},

in which γᵢ^{t} is the scaling factor for filter i at epoch t, and γ̅ᵢ^{t}, γ̅ᵢ^{t-1} are Running Average of Scaling Factors at epochs t, t−1 respectively, and k is the damping factor of the running average.

Note that for k=1, then γ̅ᵢ^{t}=γᵢ^{t} falling back to the special case described above.

According to an embodiment, all regularization terms in the objective function may be gradually switched off by:

Loss=Error+a×(weight redundancy+pruning-loss),

in which a is the annealing factor which may change from 1.0 to 0.0 during the learning stage. This option helps to deal with undesired local minima introduced by regularization terms.

The alternative pruning schemes described above may be applied in the on-line mode as well. The alternative pruning schemes comprise diversity based pruning, scaling factor based pruning and a combination approach, wherein the scaling factor based pruning and the diversity based pruning are combined.

The pruning may be performed at two stages, i.e. the pruning may comprise layer-wise pruning and network-wise pruning. This two-stage pruning scheme improves adaptability and flexibility. Further, it removes potential risks of network collapses which may be a problem in a simple network-wise pruning scheme.

The neural network compression framework may be applied to a given neural network architecture to be trained with a dataset of examples for a specific task, such as an image classification task, an image segmentation task, an image object detection task, and/or a video object tracking task. Dataset may comprise e.g. image data or video data. The neural network compression method and apparatus disclosed herein enables efficient, error resilient and safe transmission and reception of the neural networks among device or service vendors.

An apparatus may comprise at least one processor; at least one memory including computer program code; the at least one memory and the computer program code configured to, with the at least one processor, cause the apparatus at least to train a neural network by applying an optimization loss function, wherein the optimization loss function considers empirical errors and model redundancy; prune a trained neural network by removing one or more filters that have insignificant contributions from a set of filters; and provide the pruned neural network for transmission.

The apparatus may be further caused to measure filter diversities based on normalized cross correlations between weights of filters of the set of filters.

The apparatus may be further caused to form a diversity matrix based on pair-wise normalized cross correlations quantified for a set of filter weights at layers of the neural network.

The apparatus may be further caused to estimate accuracy of the pruned neural network; and retrain the pruned neural network if the accuracy of the pruned neural network is below a pre-defined threshold.

The apparatus may be further caused to estimate the pruning loss, the estimating comprising computing a first sum of scaling factors of filters to be removed from the set of filters after training; computing a second sum of scaling factors of the set of filters; and forming a ratio of the first sum and the second sum.

The apparatus may be further caused to, for mini-batches of a training stage: rank filters of the set of filters according to scaling factors; select the filters that are below a threshold percentile of the ranked filters; prune the selected filters temporarily during optimization of one of the mini-batches; iteratively repeat the ranking, selecting and pruning for the mini-batches.

It is obvious that the present invention is not limited solely to the above-presented embodiments, but it can be modified within the scope of the appended claims.

1-21. (canceled)

22. An apparatus, comprising at least one processor; at least one memory including computer program code; the at least one memory and the computer program code configured to, with the at least one processor, cause the apparatus at least to:
train a neural network by applying an optimization loss function, wherein the optimization loss function considers empirical errors and model redundancy;
prune a trained neural network by removing one or more filters that have insignificant contributions from a set of filters; and
provide the pruned neural network for transmission.

23. The apparatus according to claim 22, wherein the apparatus is further caused to:
determine filter diversities based on normalized cross correlations between weights of filters of the set of filters.

24. The apparatus according to claim 22, wherein the apparatus is further caused to:
form a diversity matrix based on pair-wise normalized cross correlations quantified for a set of filter weights at layers of the neural network.

25. The apparatus according to claim 22, wherein the apparatus is further caused to:
estimate accuracy of the pruned neural network; and
retrain the pruned neural network when the accuracy of the pruned neural network is below a pre-defined threshold.

26. The apparatus according to claim 22, wherein the optimization loss function further considers estimated pruning loss, and wherein to train the neural network, the apparatus is further caused to: minimize the optimization loss function and the pruning loss.

27. The apparatus according to claim 26, wherein the apparatus is further caused to:
estimate the pruning loss, and wherein to estimate the pruning loss, the apparatus is further caused to:
compute a first sum of scaling factors of the one or more filters to be removed from the set of filters after training;
compute a second sum of scaling factors of the set of filters; and
form a ratio of the first sum and the second sum.

28. The apparatus according to claim 26, wherein the apparatus is further caused to iteratively repeat the following for mini-batches of a training stage:
rank filters of the set of filters according to scaling factors;
select the filters that are below a threshold percentile of the ranked filters; and
prune the selected filters temporarily during optimization of one of the mini-batches.

29. The apparatus according to claim 28, wherein the threshold percentile is user specified and is fixed during training.

30. The apparatus according to claim 28, wherein the threshold percentile is dynamically changed from 0 to a user specified target percentile.

31. The apparatus according to claim 28, wherein the filters are ranked according to a running average of scaling factors.

32. The apparatus according to claim 26, wherein a sum of the model redundancy and the pruning loss is gradually switched off from the optimization loss function by multiplying with a factor changing from 1 to 0 during the training.

33. The apparatus according to claim 22, wherein to prune the trained neural network, the apparatus is further caused to:
rank filters of the set of filters based on column-wise summation of a diversity matrix; and
prune the filters that are below a threshold percentile of the ranked filters.

34. The apparatus according to claim 22, wherein to prune the trained neural network, the apparatus is further caused to:
rank the filters of the set of filters based on an importance scaling factor; and
prune the filters that are below a threshold percentile of the ranked filters.

35. The apparatus according to claim 22, wherein to prune the trained neural network, the apparatus is further caused to:
rank the filters of the set of filters based on column-wise summation of a diversity matrix and an importance scaling factor; and
prune the filters that are below a threshold percentile of the ranked filters.

36. The apparatus according to claim 22, wherein to prune the trained neural network, the apparatus is further caused to: layer-wise prune and network-wise prune.

37. A method for neural network compression, comprising:
training a neural network by applying an optimization loss function, wherein the optimization loss function considers empirical errors and model redundancy;
pruning a trained neural network by removing one or more filters that have insignificant contributions from a set of filters; and
providing the pruned neural network for transmission.

38. The method according to claim 37, further comprising:
determining filter diversities based on normalized cross correlations between weights of filters of the set of filters.

39. The method according to claim 37, wherein the optimization loss function further considers estimated pruning loss and wherein training the neural network comprises minimizing the optimization loss function and the pruning loss.

40. The method according to claim 39, further comprising:
estimating the pruning loss, the estimating comprising:
computing a first sum of scaling factors of the one or more filters to be removed from the set of filters after training;
computing a second sum of scaling factors of the set of filters; and
forming a ratio of the first sum and the second sum.

41. A computer program comprising computer program code configured to, when executed on at least one processor, cause an apparatus to:
train a neural network by applying an optimization loss function, wherein the optimization loss function considers empirical errors and model redundancy;
prune a trained neural network by removing one or more filters that have insignificant contributions from a set of filters; and
provide the pruned neural network for transmission.
